(19) United States
(12) Patent Application Publication
(10) Pub. No.: US 2026/0075459 A1
(43) Pub. Date: Mar. 12, 2026

(54) TECHNIQUES FOR PREDICTION OF UPLINK TRAFFIC BURSTS

(71) Applicant: QUALCOMM Incorporated, San Diego, CA (US)

(72) Inventors: Karl Georg HAMPEL, Jersey City, NJ (US); Junyi LI, Greentown, PA (US); Hua WANG, Basking Ridge, NJ (US); Tien Viet NGUYEN, Bridgewater, NJ (US)

(21) Appl. No.: 18/828,858

(22) Filed: Sep. 9, 2024

(51) Int. Cl. H04W 28/02; H04W 72/1268

(52) U.S. Cl. CPC H04W 28/0278; H04W 72/1268

(57) ABSTRACT

Methods, systems, and devices for method for wireless communication are described. A user equipment (UE) may transmit, a predictive buffer status report associated with a request for a grant for transmission of uplink data and a first time. In response to the predictive buffer status report, the UE may receive the grant for transmission of the uplink data for a second time. In some cases, the second time may be related to the first time. The UE may transmit the uplink data based on the grant. In some cases, the first time and the second time may include absolute times. In some cases, the first time may include a first relative time with respect to an event and the second time may include a second relative time with respect to the event.

### FIELD OF TECHNOLOGY

The following relates to method for wireless communication, including techniques for prediction of uplink traffic bursts.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, a predictive buffer status report associated with a request for a grant for transmission of uplink data and a first time, in response to the predictive buffer status report, receiving the grant for transmission of the uplink data for a second time, where the second time is related to the first time, and transmitting the uplink data based on the grant.

A UE for wireless communications is described. The UE may include one or more memories storing processor executable code, and one or more processors coupled with the one or more memories. The one or more processors may individually or collectively be operable to execute the code to cause the UE to transmit, a predictive buffer status report associated with a request for a grant for transmission of uplink data and a first time, in response to the predictive buffer status report, receiving the grant for transmission of the uplink data for a second time, where the second time is related to the first time, and transmit the uplink data based on the grant.

Another UE for wireless communications is described. The UE may include means for transmitting, a predictive buffer status report associated with a request for a grant for transmission of uplink data and a first time, means for in response to the predictive buffer status report, receiving the grant for transmission of the uplink data for a second time, where the second time is related to the first time, and means for transmitting the uplink data based on the grant.

A non-transitory computer-readable medium storing code for wireless communications is described. The code may include instructions executable by one or more processors to transmit, a predictive buffer status report associated with a request for a grant for transmission of uplink data and a first time, in response to the predictive buffer status report, receiving the grant for transmission of the uplink data for a second time, where the second time is related to the first time, and transmit the uplink data based on the grant.

In some examples of the method, UEs, and non-transitory computer-readable medium described herein, the first time and the second time includes absolute times.

In some examples of the method, UEs, and non-transitory computer-readable medium described herein, the first time includes a first relative time with respect to an event and the second time includes a second relative time with respect to the event.

In some examples of the method, UEs, and non-transitory computer-readable medium described herein, the predictive buffer status report includes an indicator for a type of event and the type of event serves as a reference for the first time and the second time.

In some examples of the method, UEs, and non-transitory computer-readable medium described herein, receiving the grant may include operations, features, means, or instructions for receiving, in response to the predictive buffer status report, the grant for transmission of the uplink data including an indication of the second time.

In some examples of the method, UEs, and non-transitory computer-readable medium described herein, receiving the grant may include operations, features, means, or instructions for receiving, in response to the predictive buffer status report, the grant for transmission of the uplink data after the first time.

Some examples of the method, UEs, and non-transitory computer-readable medium described herein may further include operations, features, means, or instructions for transmitting, at a third time that occurs after the first time, a scheduling request for the grant, where the grant for transmission of the uplink data may be received in response to transmission of the scheduling request.

Some examples of the method, UEs, and non-transitory computer-readable medium described herein may further include operations, features, means, or instructions for observing, at a third time, an event and receiving, a threshold time period after observing the event, the grant for transmission of the uplink data.

In some examples of the method, UEs, and non-transitory computer-readable medium described herein, the event includes a downlink data transmission or an uplink data transmission or both.

In some examples of the method, UEs, and non-transitory computer-readable medium described herein, the predictive buffer status report indicates a predicted traffic burst size, a predicted time of burst arrival, a predicted time interval for data availability after an event, an event descriptor, a confidence indicator.

In some examples of the method, UEs, and non-transitory computer-readable medium described herein, the event includes at least one of a successful downlink transmission, a successful uplink transmission, and a traffic characterization.

Some examples of the method, UEs, and non-transitory computer-readable medium described herein may further include operations, features, means, or instructions for transmitting a message indicating at least one of a capability to support predictive buffer status reporting, a capability to support time-based predictive buffer status reporting, a capability to support event-based predictive buffer status reporting, and one or more event descriptors.

Some examples of the method, UEs, and non-transitory computer-readable medium described herein may further include operations, features, means, or instructions for receiving a control signal indicating for the UE to use predictive buffer status reporting in accordance with one or more of a type of a predictive buffer status report, an event descriptor, or both.

Some examples of the method, UEs, and non-transitory computer-readable medium described herein may further include operations, features, means, or instructions for transmitting a message indicating information associated with a usage of one or more predictive buffer status reports.

Some examples of the method, UEs, and non-transitory computer-readable medium described herein may further include operations, features, means, or instructions for transmitting a message indicating at least one of a quantity of predictive buffer status reports transmitted per UE, a quantity of predictive buffer status reports transmitted per time interval, a type of a previously transmitted predictive buffer status report, a probability that the uplink data becomes available at the second time, a correlation of a probability associated with uplink data becoming available and a confidence value provided by the UE, and a time difference between the second time indicated in the predictive buffer status report and an actual time that the uplink data becomes available.

In some examples of the method, UEs, and non-transitory computer-readable medium described herein, the predictive buffer status report includes at least one of an indication of an absolute time with reference to an universal time, an absolute time with reference to a system frame number, and a time difference indication.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for prediction of uplink traffic bursts in accordance with one or more aspects of the present disclosure.

FIG. 2 shows an example of a wireless communications system that supports techniques for prediction of uplink traffic bursts in accordance with one or more aspects of the present disclosure.

FIGS. 3 through 8 show examples of process flows that support techniques for prediction of uplink traffic bursts in accordance with one or more aspects of the present disclosure.

FIGS. 9 and 10 show block diagrams of devices that support techniques for prediction of uplink traffic bursts in accordance with one or more aspects of the present disclosure.

FIG. 11 shows a block diagram of a communications manager that supports techniques for prediction of uplink traffic bursts in accordance with one or more aspects of the present disclosure.

FIG. 12 shows a diagram of a system including a device that supports techniques for prediction of uplink traffic bursts in accordance with one or more aspects of the present disclosure.

FIGS. 13 through 16 show flowcharts illustrating methods that support techniques for prediction of uplink traffic bursts in accordance with one or more aspects of the present disclosure.

### DETAILED DESCRIPTION

In some wireless communications systems, a UE may schedule uplink data using a sequence of transmissions. In particular, the UE may send an uplink service request followed by reception of a downlink transmission including a grant for a buffer status report. The UE may then transmit the buffer status report requesting an uplink grant for transmission of uplink data. In response to reception of the uplink grant, the UE may transmit the uplink data. This handshake technique prior to the transmission of uplink data may introduce latency. Additionally, or alternatively, the UE may transmit the buffer status report once the uplink data becomes available, thereby further increasing the latency.

One or more aspects of the present disclosure provide for enhancement of uplink data scheduling latency for non-periodic traffic using artificial intelligence to predict data arrival time. In particular, the UE may implement an artificial intelligence model to predict a time for uplink data generation at the UE. In some examples, the UE may identify a time at which uplink data is available for transmission. For instance, the UE may identify that uplink data is generated in response to an event (reception of a downlink transmission). Upon identification of the event, the UE may determine a time at which the uplink data (e.g., uplink data burst) will be available at the UE. In such cases, the UE may request, in a predictive buffer status report, for an uplink grant for uplink data that will be available at a future time. Thus, the request for uplink resources (via predictive buffer status report) may be performed in parallel to the generation of the uplink data. In particular, the UE may make the request for uplink resources based on a predicted buffer status and a predicted time of data availability, thereby saving time and decreasing latency.

Aspects of the disclosure are initially described in the context of wireless communications systems. Aspects of the disclosure are further illustrated by and described with reference to process flows. Aspects of the disclosure are further illustrated by and described with reference to apparatus diagrams, system diagrams, and flowcharts that relate to techniques for prediction of uplink traffic bursts.

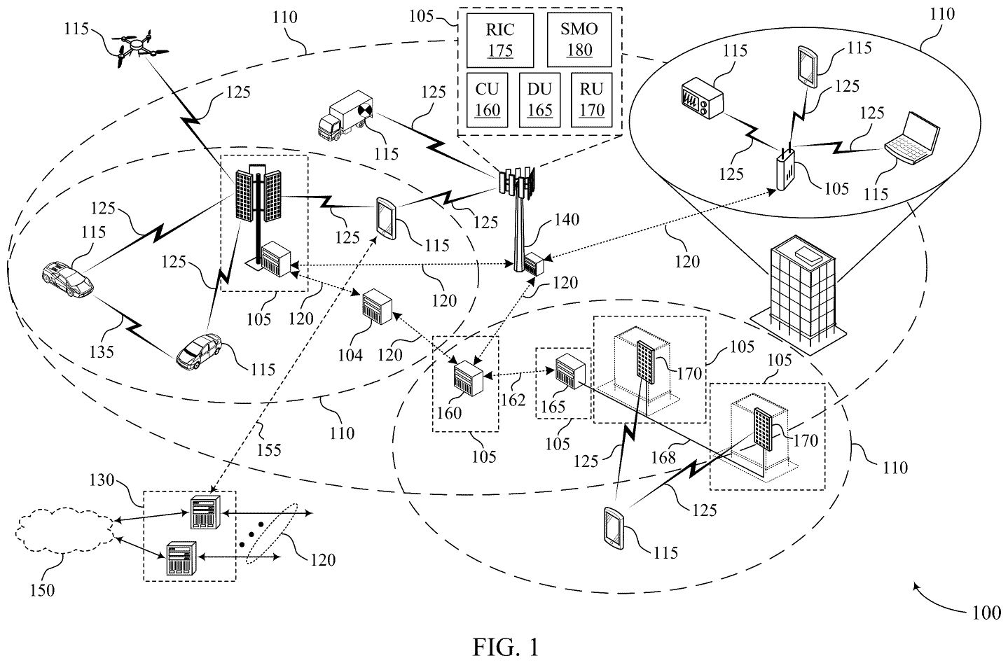

FIG. 1 shows an example of a wireless communications system 100 that supports techniques for prediction of uplink traffic bursts in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, uplink data scheduling via dynamic grant may include transmission of an uplink service request, reception of a downlink grant for buffer status report, transmission of an uplink buffer status report, reception of a downlink grant for data, and transmission of uplink data. This four-way handshake prior to the transmission of uplink data may introduce latency in communication. In some cases, the uplink latency may be large and may impact user experience (distributed inter frame spacing value of 50 us). To reduce this latency, in some examples, wireless communications systems may support configured grant for periodic traffic. The configured grant, however, may provide latency benefits for periodic traffic. In some cases, to reduce this latency, some wireless communications systems may support preemptive buffer status report (which may apply to IAB nodes). In some examples, an IAB node may send a preemptive buffer status report to its parent node based on data it expects to receive from the child node (rather than data it has actually buffered).

Aspects of the present disclosure provide for techniques for improving uplink data scheduling latency for non-periodic traffic, where traffic bursts are predicted at the UE. In particular, an application may send an uplink traffic burst based on a deterministic consequence of an event followed by a procedural flow. The event may be initiated by one or more of the application itself, an interrupt set by the operating system, the arrival of a data packet, or any combination. For many applications, the procedural flow following the event may be deterministic in time (e.g., in case it takes a specific computation to the generate the data for the uplink traffic burst). In some wireless communications systems, a modem may wait until it has the actual data for the uplink traffic burst available in the buffer, prior to initiating the buffer status request procedure. However, according to aspects of the present disclosure, an artificial intelligence system in the UE 115-a may determine (or predict) a time for uplink data generation after an event. Then, when the event occurs, the request for uplink resources may be performed in parallel to the generation of the uplink data. In some examples, the request for uplink resources may be based on a predicted buffer status and the predicted time of data availability.

According to one or more aspects of the present disclosure, a UE 115 may transmit, a predictive buffer status report associated with a request for a grant for transmission of uplink data and a first time. In response to the predictive buffer status report, the UE 115 may receive the grant for transmission of the uplink data for a second time, where the second time is related to the first time. The UE 115 may then transmit the uplink data based on the grant.

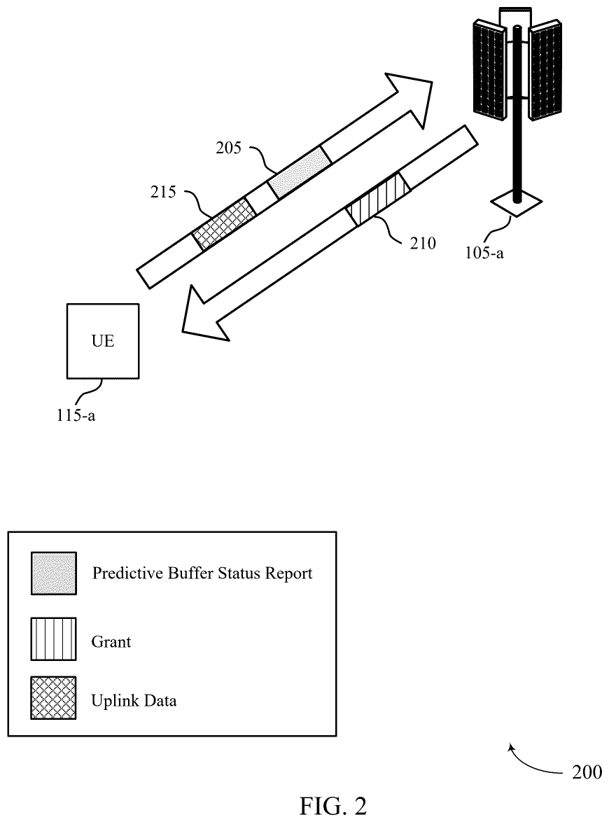

FIG. 2 shows an example of a wireless communications system 200 that supports techniques for prediction of uplink traffic bursts in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described with reference to FIG. 1.

One or more aspects of the present disclosure provide for transmission of a predictive buffer status report 205. In particular, when the UE 115-a predicts an uplink traffic burst of predictable size at a predictable future time, the UE 115-a may send a predictive buffer status report 205. For example, the UE 115-a may transmit, a predictive buffer status report 205 associated with a request for a grant for transmission of uplink data and a first time. The predictive buffer status report 205 (e.g., buffer status report MAC control element (MAC CE)) may include one or more of a predicted traffic burst size and a predicted time of burst arrival (e.g., time based prediction). Alternatively, the predictive buffer status report 205 may include an indication of predicted time interval after a network and device-discernable event together with an event descriptor (such as the successful transmission of a downlink or uplink packet with a specific logical channel identifier (e.g., event-based burst prediction). In some cases, the predictive buffer status report 205 may further include an indicator associated with a confidence that the burst will occur. In some examples, the predictive buffer status report 205 may be associated with a list of predictable uplink traffic bursts.

In response to the predictive buffer status report 205, the UE 115-a may receive a grant 210 (e.g., an uplink dynamic grant) prior to the uplink data being available (e.g., via MAC CE). For example, in response to the predictive buffer status report 205, the UE 115-a may receive the grant 210 for transmission of the uplink data for a second time, where the second time is related to the first time. The UE 115-a may transmit an uplink data 215 based on the grant 210. The grant 210 may be associated with a predicted time or a predicted time interval. The grant 210 associated with a predicted time (or a little later) may be referred to as a time-based burst prediction. Alternatively, the grant 210 associated with a predicted time-interval after the event (or a little later) may be referred to as an event-based burst prediction.

In some examples, the response to the predictive buffer status report 205, the UE 115-a may receive an uplink dynamic grant when the uplink data is available (e.g., via downlink control information). In some examples, the network entity 105-a may transmit a dynamic grant after the predicted time of the uplink data burst (or a little later). Additionally, or alternatively, the network entity 105-a may transmit a dynamic grant upon receiving a scheduling request after the predicted time of the uplink data burst. While this may potentially impact the benefit of the predictive buffer status report 205, it avoids unnecessary uplink resource utilization in case the prediction was wrong.

In some examples, the UE 115-a may indicate, in a UE capability report, an indication of a capability of the UE to support predictive buffer status reporting. The capabilities may further differentiate the support for time-based and event-based prediction.

In some examples, the UE 115-a may request support for the use of predictive buffer status reporting (e.g., via RRC). This request may indicate whether the predictive buffer status reporting is to be used for time-based or event-based prediction. This request may further indicate event specifiers such as a downlink traffic event, an uplink traffic event, a logical channel identifier, among others. When communicating in accordance to an event-based burst prediction, the network entity 105-a may monitor for the event described via the event descriptor in the predictive buffer status report 205. The network entity 105-a may then send the grant 210 when observing that the event condition has been met.

In some examples, the network entity 105-a may configure the UE 115-a to use predictive buffer status reports (e.g., via RRC signaling or other control signaling). The network entity 105-a may further specify if predictive buffer status reports are used for time-based or event-based prediction. The network entity 105-a may further indicate event specifiers such as a downlink traffic event, an uplink traffic event, a logical channel identifier, etc. In some examples, the network entity 105-a may further indicate if the uplink grant is preemptive and expects an additional dynamic grant or scheduling request to be activated.

In some examples, the network entity 105-a may collect information about the usage of predictive buffer status reports (e.g., for charging purposes). The network entity 105-a or the UE 115-a may report prediction information to a data collection entity. In some examples, the prediction information may include at least one of a quantity of predictive buffer status reports transmitted per UE, a quantity of predictive buffer status reports transmitted per time interval, a type of a previously transmitted predictive buffer status report (e.g., time-based or event-based), a probability that the uplink data becomes available at a predicted time, a correlation of a probability associated with uplink data becoming available and a confidence value provided by the UE 115-a, and a time difference between the second time indicated in the predictive buffer status report and an actual time that the uplink data becomes available.

Additionally, or alternatively, a modem on the UE 115-a may support an application programming interface (API) for upper layers to provide information on one or more of registering for uplink burst notifications and notifications on uplink bursts. The registering information may include information on traffic type indicator (e.g., flow descriptor, which the modem can translate to a logical channel identifier) and event type descriptor. In some examples, the notification on uplink bursts may include information on one or more of predicted burst size(s), predicted time or time difference from an event (e.g., delta time to event), an event descriptor (e.g., none, downlink transmission, uplink transmission), details of traffic channel related to event (e.g., flow descriptor), a confidence estimate on when the traffic burst is to occur, or any combination thereof.

In some examples, an operating system on the UE 115-a may support an API for applications to provide information on one or more of registering for prediction of uplink bursts and notification on uplink bursts. In some examples, registering for prediction of uplink bursts may include information on one or more of a traffic type indicator (e.g., socket information, flow descriptor) and an event type descriptor. Additionally, or alternatively, the notification on uplink bursts may include information on one or more of predicted burst size(s), predicted time indicators (absolute or relative to event), an event descriptor (e.g., none, downlink transmission, uplink transmission), details for traffic channel related to event (e.g., flow descriptor), confidence estimate on when the traffic burst is to occur, or any combination thereof.

In some examples, the UE 115-a may receive the grant prior to a predicted time of data availability. Additionally, or alternatively, the UE 115-a may receive the grant at or after the predicted time based on the indication of the predicted time in the predicted buffer status report. In some examples, the UE 115-a may transmit a service request at or after the predicted time and may receive the grant for the uplink resource in response to the service request. The UE 115-a may further include, in the predictive buffer status report, an indication of the confidence on the availability of the uplink data at the predicted time. In such cases, the predicted time may refer to a time window after an event. In some cases, the event may refer to a successful downlink or uplink transmission, where the event may further include a traffic characterization such as a logical channel, data radio bearer, or flow. The UE 115-a may be configured to send information about the event to the network entity 105-a. In some examples, the UE 115-a may include information about the event in the predictive buffer status report. Additionally, or alternatively, the UE 115-a may send a capability information indicating a support of a predictive buffer status report to the network entity 105-a. In some examples, the absolute time indicated in the predictive buffer status report may be provided in reference to universal time coordinated (UTC) or system frame number (SFN). In some examples, a delta time (or time difference) included in the predictive buffer status report may be provided in units or subunits of seconds or in units or subunits of the system frame structure.

Thus, according to the aspects depicted herein, the UE 115-a may implement a predictive buffer status report transmission including information associated with the predicted data and a predicted time of the availability of the data for uplink transmission. The UE 115-a may then receive a grant for an uplink resource for a time at or after the predicted time and may transmit the data based on the received grant.

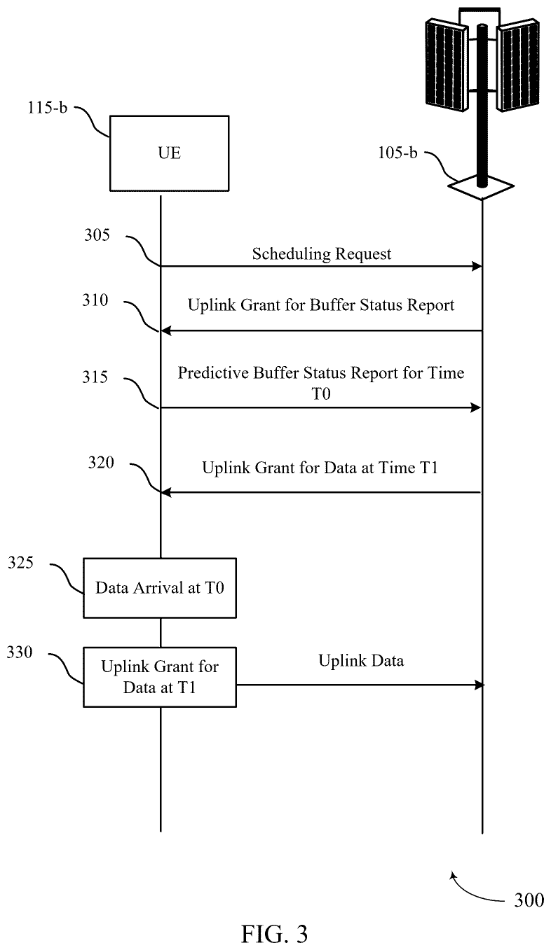

FIG. 3 shows an example of a process flow 300 that supports techniques for prediction of uplink traffic bursts in accordance with one or more aspects of the present disclosure. The process flow 300 includes a UE 115-b and a network entity 105-b, which may be examples of the corresponding devices as described with respect to FIGS. 1 and 2. The process flow 300 may describe processes related to a time-based predictive buffer status report transmission with dynamic grant for a predicted time of uplink data arrival. As depicted herein, the time-based predictive buffer status report may be used based on prediction of buffer status and time of data availability.

In the following description of the process flow 300, the operations between the UE 115-b and the network entity 105-b may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the UE 115-b may transmit a scheduling request for a grant. At 310, the UE 115-b may receive an uplink grant for buffer status report. At 315, the UE 115-b may transmit a predictive buffer status report associated with a request for a grant for transmission of uplink data and a first time. In particular, the UE 115-b may transmit the predictive buffer status report for time T0.

At 320, the UE 115-b may receive, in response to the predictive buffer status report, the grant for transmission of the uplink data that will become available at a later time (e.g., T0). The UE 115-b may receive the uplink grant for data for time T1.

At 325, the data (for transmission) may be available at time T0. At 330, the UE 115-b may transmit the uplink data based on the uplink grant. As depicted in the example of FIG. 3, the UE 115-b transmits the uplink data at or a after time T1.

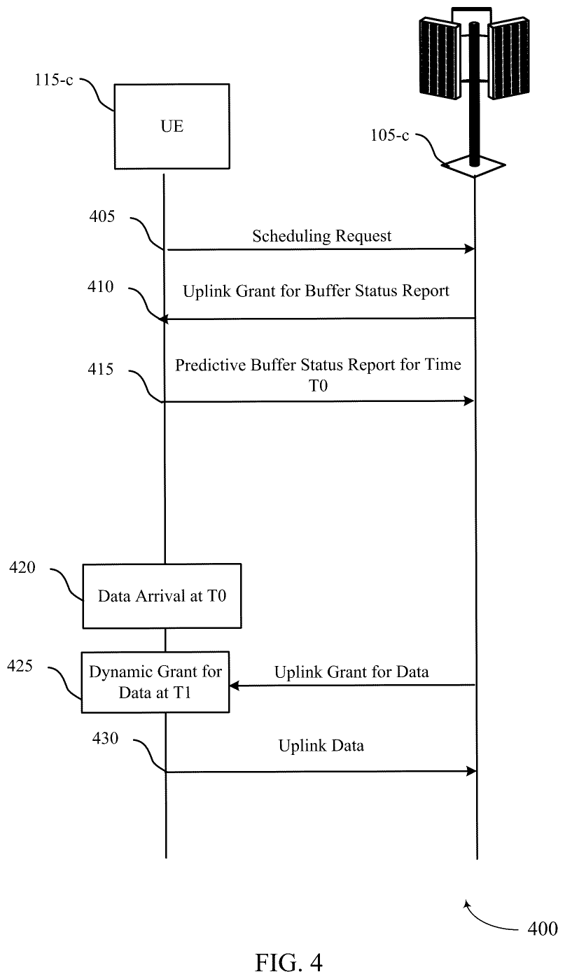

FIG. 4 shows an example of a process flow 400 that supports techniques for prediction of uplink traffic bursts in accordance with one or more aspects of the present disclosure. The process flow 400 includes a UE 115-c and a network entity 105-c, which may be examples of the corresponding devices as described with respect to FIGS. 1 and 2. The process flow 400 may describe processes related to a time-based predictive buffer status report transmission with dynamic grant at or after a predicted time of uplink data arrival. As depicted herein, the time-based predictive buffer status report may be used based on prediction of buffer status and time of data availability

In the following description of the process flow 400, the operations between the UE 115-c and the network entity 105-c may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-c may transmit a scheduling request for a grant. At 410, the UE 115-c may receive an uplink grant for buffer status report. At 415, the UE 115-c may transmit a predictive buffer status report associated with a request for a grant for transmission of uplink data and a first time. In particular, the UE 115-c may transmit the predictive buffer status report for time T0.

At 420, the data (for transmission) may be available at time T0. At 425, the UE 115-c may receive, in response to the predictive buffer status report, a dynamic grant for transmission of the uplink data. The UE 115-c may receive the uplink grant for data for time T1. At 430, UE 115-c may transmit the uplink data based on the dynamic grant.

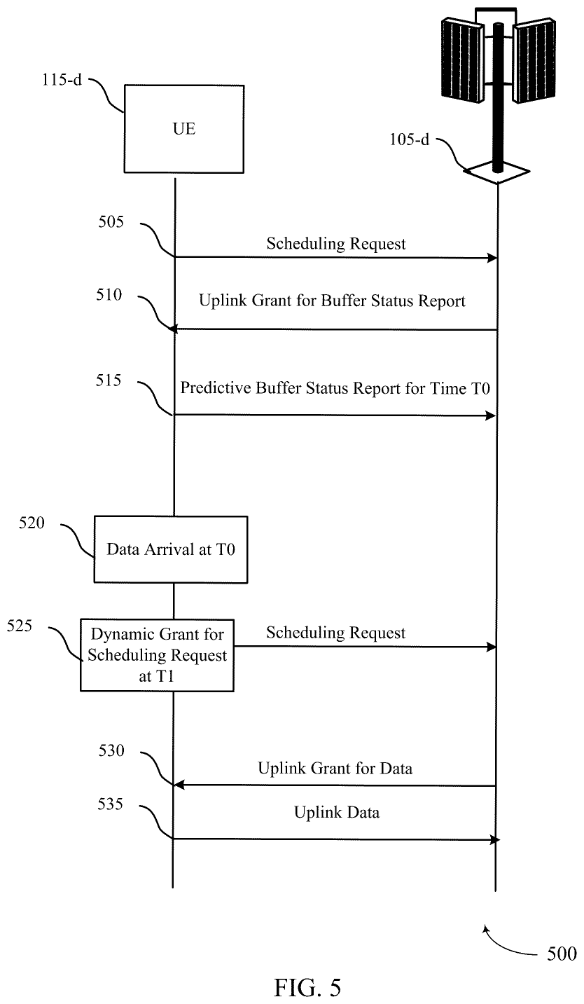

FIG. 5 shows an example of a process flow 500 that supports techniques for prediction of uplink traffic bursts in accordance with one or more aspects of the present disclosure. The process flow 500 includes a UE 115-d and a network entity 105-d, which may be examples of the corresponding devices as described with respect to FIGS. 1 and 2. The process flow 500 may describe processes related to a time-based predictive buffer status report transmission with scheduling request or dynamic at or after a time of uplink data arrival. As depicted herein, the time-based predictive buffer status report may be used based on prediction of buffer status and time of data availability.

In the following description of the process flow 500, the operations between the UE 115-d and the network entity 105-d may be performed in a different order than the example order shown. Some operations may also be omitted from the process flow 500, and other operations may be added to the process flow 500. Further, although some operations or signaling may be shown to occur at different times for discussion purposes, these operations may actually occur at the same time.

At 505, the UE 115-d may transmit a scheduling request for a grant. At 510, the UE 115-d may receive an uplink grant for buffer status report. At 515, the UE 115-d may transmit a predictive buffer status report associated with a request for a grant for transmission of uplink data and a first time. In particular, the UE 115-d may transmit the predictive buffer status report for time T0.

At 520, the data (for transmission) may be available at time T0. At 525, the UE 115-d may transmit a scheduling request using a dynamic grant for the scheduling request. For instance, the UE 115-d may receive, in response to the predictive buffer status report, a dynamic grant for transmission of the uplink data. At 530, the UE 115-d may receive the uplink grant for data for time T1. At 535, UE 115-d may transmit the uplink data based on the uplink grant.

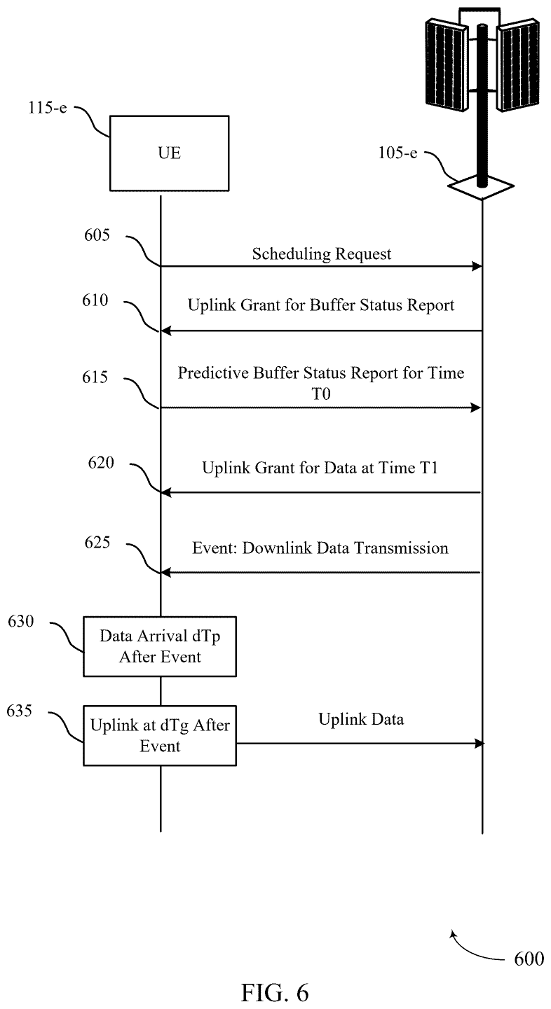

FIG. 6 shows an example of a process flow 600 that supports techniques for prediction of uplink traffic bursts in accordance with one or more aspects of the present disclosure. The process flow 600 includes a UE 115-e and a network entity 105-e, which may be examples of the corresponding devices as described with respect to FIGS. 1 and 2. The process flow 600 may describe processes related to an event-based predictive buffer status report transmission with dynamic grant for a predicted time of uplink data arrival. As depicted herein, the event-based predictive buffer status report may be used based on prediction of buffer status and a time interval after a network or UE-discernable event. In some cases, the event may include a successful transmission of a downlink or uplink packet.

In the following description of the process flow 600, the operations between the UE 115-e and the network entity 105-e may be performed in a different order than the example order shown. Some operations may also be omitted from the process flow 600, and other operations may be added to the process flow 600. Further, although some operations or signaling may be shown to occur at different times for discussion purposes, these operations may actually occur at the same time.

At 605, the UE 115-e may transmit a scheduling request for a grant. At 610, the UE 115-e may receive an uplink grant for buffer status report. At 615, the UE 115-e may transmit a predictive buffer status report associated with a request for a grant for transmission of uplink data and a first time. In particular, the UE 115-e may transmit the predictive buffer status report for time T0.

At 620, the UE 115-e may receive, in response to the predictive buffer status report, the grant for transmission of the uplink data that will become available at a later time (e.g., T0). The time for data arrival may be predicted based on occurrence of an event. In some examples, the UE 115-e may receive the uplink grant for data for time dT_{g} after occurrence of the event.

At 625, the UE 115-e may determine occurrence of the event. In the example of FIG. 6, the event may be a downlink data transmission. At 630, data (for transmission) may be available at time dTₚ after the event. At 635, the UE 115-e may transmit the uplink data based on the uplink grant. As depicted in the example of FIG. 6, the UE 115-e may transmit the uplink data at a threshold time dT_{g} after occurrence of the event.

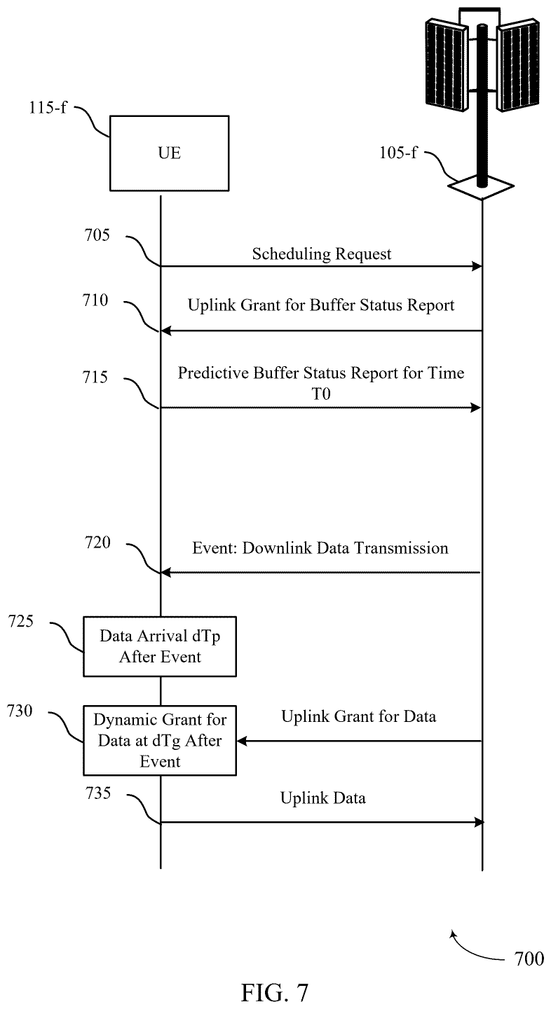

FIG. 7 shows an example of a process flow 700 that supports techniques for prediction of uplink traffic bursts in accordance with one or more aspects of the present disclosure. The process flow 700 includes a UE 115-f and a network entity 105-f, which may be examples of the corresponding devices as described with respect to FIGS. 1 and 2. The process flow 700 may describe processes related to an event-based predictive buffer status report transmission with dynamic grant at or after a predicted time of uplink data arrival. As depicted herein, the event-based predictive buffer status report may be used based on prediction of buffer status and a time interval after a network or UE-discernable event. In some cases, the event may include a successful transmission of a downlink or uplink packet.

In the following description of the process flow 700, the operations between the UE 115-f and the network entity 105-f may be performed in a different order than the example order shown. Some operations may also be omitted from the process flow 700, and other operations may be added to the process flow 700. Further, although some operations or signaling may be shown to occur at different times for discussion purposes, these operations may actually occur at the same time.

At 705, the UE 115-f may transmit a scheduling request for a grant. At 710, the UE 115-f may receive an uplink grant for buffer status report. At 715, the UE 115-f may transmit a predictive buffer status report associated with a request for a grant for transmission of uplink data and a first time. In particular, the UE 115-f may transmit the predictive buffer status report for time T0.

At 720, the UE 115-f may determine occurrence of an event. In the example of FIG. 7, the event may be a downlink data transmission. At 725, data (for transmission) may be available at time dTₚ after the event. At 730, the UE 115-f may receive a dynamic grant for data transmission at time dT_{g} after occurrence of the event. At 735, the UE 115-f may transmit the uplink data based on the dynamic grant.

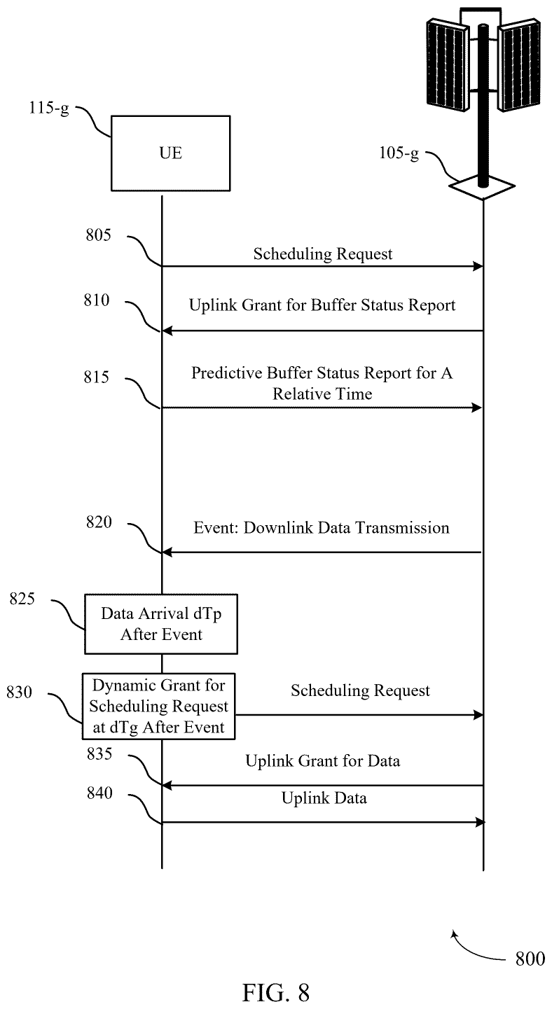

FIG. 8 shows an example of a process flow 800 that supports techniques for prediction of uplink traffic bursts in accordance with one or more aspects of the present disclosure. The process flow 800 includes a UE 115-g and a network entity 105-g, which may be examples of the corresponding devices as described with respect to FIGS. 1 and 2. The process flow 800 may describe processes related to an event-based predictive buffer status report transmission with scheduling request and dynamic grant at or after a time of uplink data arrival. As depicted herein, the event-based predictive buffer status report may be used based on prediction of buffer status and a time interval after a network or UE-discernable event. In some cases, the event may include a successful transmission of a downlink or uplink packet.

In the following description of the process flow 800, the operations between the UE 115-g and the network entity 105-g may be performed in a different order than the example order shown. Some operations may also be omitted from the process flow 800, and other operations may be added to the process flow 800. Further, although some operations or signaling may be shown to occur at different times for discussion purposes, these operations may actually occur at the same time.

At 805, the UE 115-g may transmit a scheduling request for a grant. At 810, the UE 115-g may receive an uplink grant for buffer status report. At 815, the UE 115g may transmit a predictive buffer status report associated with a request for a grant for transmission of uplink data and a first relative time with respect to an event. In particular, the UE 115g may transmit the predictive buffer status report for time dTp after an event such as a UL or DL transmission.

At 820, the UE 115-g may determine occurrence of such an event. In the example of FIG. 8, the event may be a downlink data transmission. At 825, data (for transmission) may be available at time dTₚ after the event. At 830, the UE 115-g may receive a dynamic grant for scheduling request for data at time dT_{g} after occurrence of the event. At 835, the UE 115-g may receive an uplink grant in response to the scheduling request at 830. At 840, the UE 115-g may transmit the uplink data based on the uplink grant.

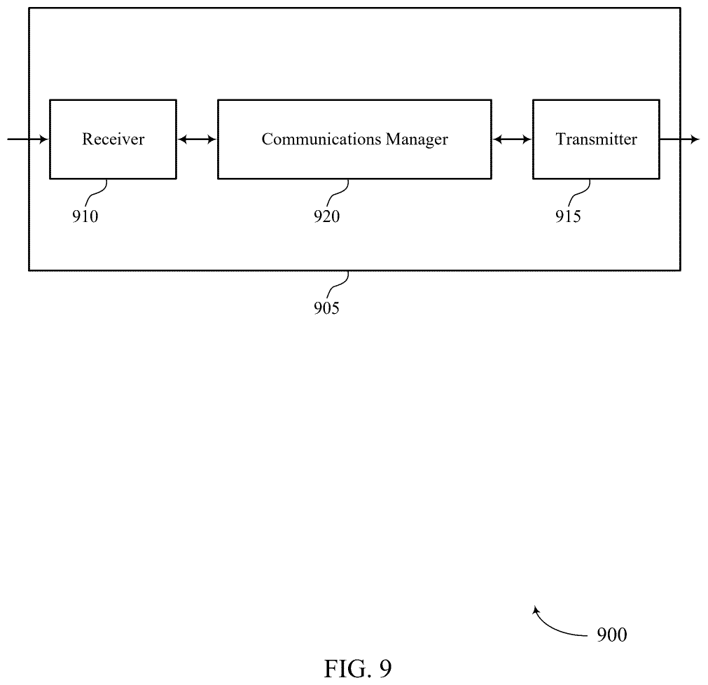

FIG. 9 shows a block diagram 900 of a device 905 that supports techniques for prediction of uplink traffic bursts in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for prediction of uplink traffic bursts). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for prediction of uplink traffic bursts). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of techniques for prediction of uplink traffic bursts as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting, a predictive buffer status report associated with a request for a grant for transmission of uplink data and a first time. The communications manager 920 is capable of, configured to, or operable to support a means for in response to the predictive buffer status reporting, receiving the grant for transmission of the uplink data for a second time, where the second time is related to the first time. The communications manager 920 is capable of, configured to, or operable to support a means for transmitting the uplink data based on the grant.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

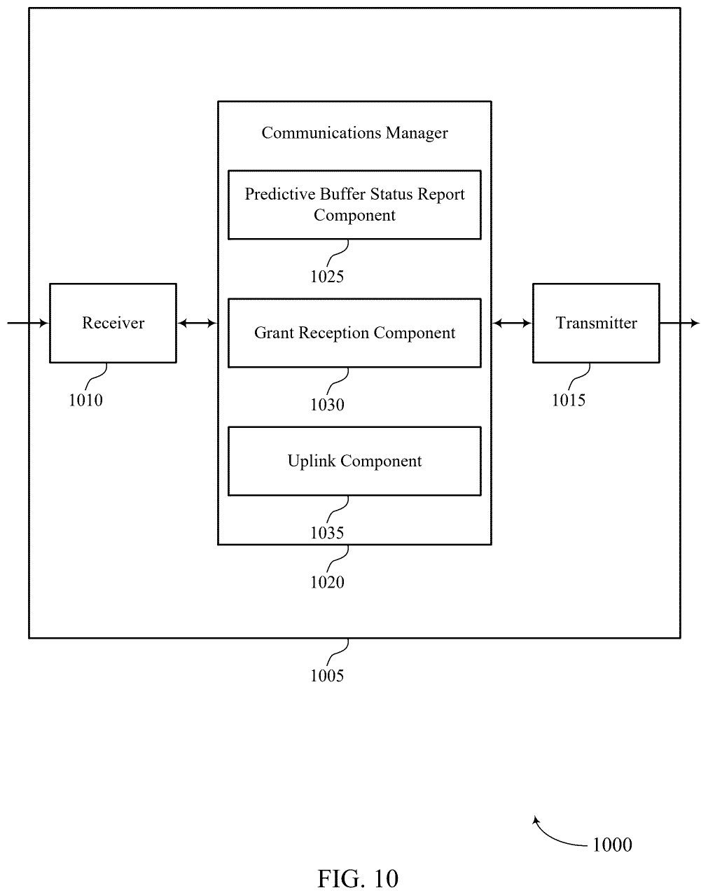

FIG. 10 shows a block diagram 1000 of a device 1005 that supports techniques for prediction of uplink traffic bursts in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for prediction of uplink traffic bursts). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for prediction of uplink traffic bursts). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for prediction of uplink traffic bursts as described herein. For example, the communications manager 1020 may include a predictive buffer status report component 1025, a grant reception component 1030, an uplink component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The predictive buffer status report component 1025 is capable of, configured to, or operable to support a means for transmitting, a predictive buffer status report associated with a request for a grant for transmission of uplink data and a first time. The grant reception component 1030 is capable of, configured to, or operable to support a means for in response to the predictive buffer status report, receiving the grant for transmission of the uplink data for a second time, where the second time is related to the first time. The uplink component 1035 is capable of, configured to, or operable to support a means for transmitting the uplink data based on the grant.

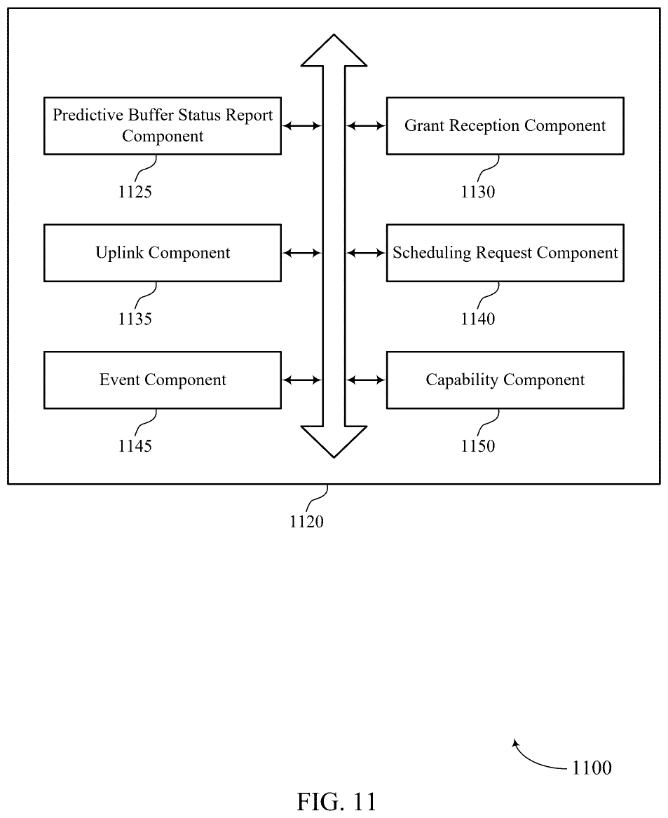

FIG. 11 shows a block diagram 1100 of a communications manager 1120 that supports techniques for prediction of uplink traffic bursts in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for prediction of uplink traffic bursts as described herein. For example, the communications manager 1120 may include a predictive buffer status report component 1125, a grant reception component 1130, an uplink component 1135, a scheduling request component 1140, an event component 1145, a capability component 1150, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The predictive buffer status report component 1125 is capable of, configured to, or operable to support a means for transmitting, a predictive buffer status report associated with a request for a grant for transmission of uplink data and a first time. The grant reception component 1130 is capable of, configured to, or operable to support a means for in response to the predictive buffer status report, receiving the grant for transmission of the uplink data for a second time, where the second time is related to the first time. The uplink component 1135 is capable of, configured to, or operable to support a means for transmitting the uplink data based on the grant.

In some examples, the first time and the second time includes absolute times. In some examples, the first time includes a first relative time with respect to an event and the second time includes a second relative time with respect to the event. In some examples, the predictive buffer status report includes an indicator for a type of event. In some examples, the type of event serves as a reference for the first time and the second time.

In some examples, to support receiving the grant, the grant reception component 1130 is capable of, configured to, or operable to support a means for receiving, in response to the predictive buffer status report, the grant for transmission of the uplink data including an indication of the second time.

In some examples, to support receiving the grant, the grant reception component 1130 is capable of, configured to, or operable to support a means for receiving, in response to the predictive buffer status report, the grant for transmission of the uplink data after the first time.

In some examples, the scheduling request component 1140 is capable of, configured to, or operable to support a means for transmitting, at a third time that occurs after the first time, a scheduling request for the grant, where the grant for transmission of the uplink data is received in response to transmission of the scheduling request.

In some examples, the event component 1145 is capable of, configured to, or operable to support a means for observing, at a third time, an event. In some examples, the grant reception component 1130 is capable of, configured to, or operable to support a means for receiving, a threshold time period after observing the event, the grant for transmission of the uplink data. In some examples, the event includes a downlink data transmission or an uplink data transmission or both.

In some examples, the predictive buffer status report indicates a predicted traffic burst size, a predicted time of burst arrival, a predicted time interval for data availability after an event, an event descriptor, a confidence indicator. In some examples, the event includes at least one of a successful downlink transmission, a successful uplink transmission, and a traffic characterization.

In some examples, the capability component 1150 is capable of, configured to, or operable to support a means for transmitting a message indicating at least one of a capability to support predictive buffer status reporting, a capability to support time-based predictive buffer status reporting, a capability to support event-based predictive buffer status reporting, and one or more event descriptors.

In some examples, the predictive buffer status report component 1125 is capable of, configured to, or operable to support a means for receiving a control signal indicating for the UE to use predictive buffer status reporting in accordance with one or more of a type of a predictive buffer status report, an event descriptor, or both.

In some examples, the predictive buffer status report component 1125 is capable of, configured to, or operable to support a means for transmitting a message indicating information associated with a usage of one or more predictive buffer status reports.

In some examples, the predictive buffer status report component 1125 is capable of, configured to, or operable to support a means for transmitting a message indicating at least one of a quantity of predictive buffer status reports transmitted per UE, a quantity of predictive buffer status reports transmitted per time interval, a type of a previously transmitted predictive buffer status report, a probability that the uplink data becomes available at the second time, a correlation of a probability associated with uplink data becoming available and a confidence value provided by the UE, and a time difference between the second time indicated in the predictive buffer status report and an actual time that the uplink data becomes available.

In some examples, the predictive buffer status report includes at least one of an indication of an absolute time with reference to an universal time, an absolute time with reference to a system frame number, and a time difference indication.

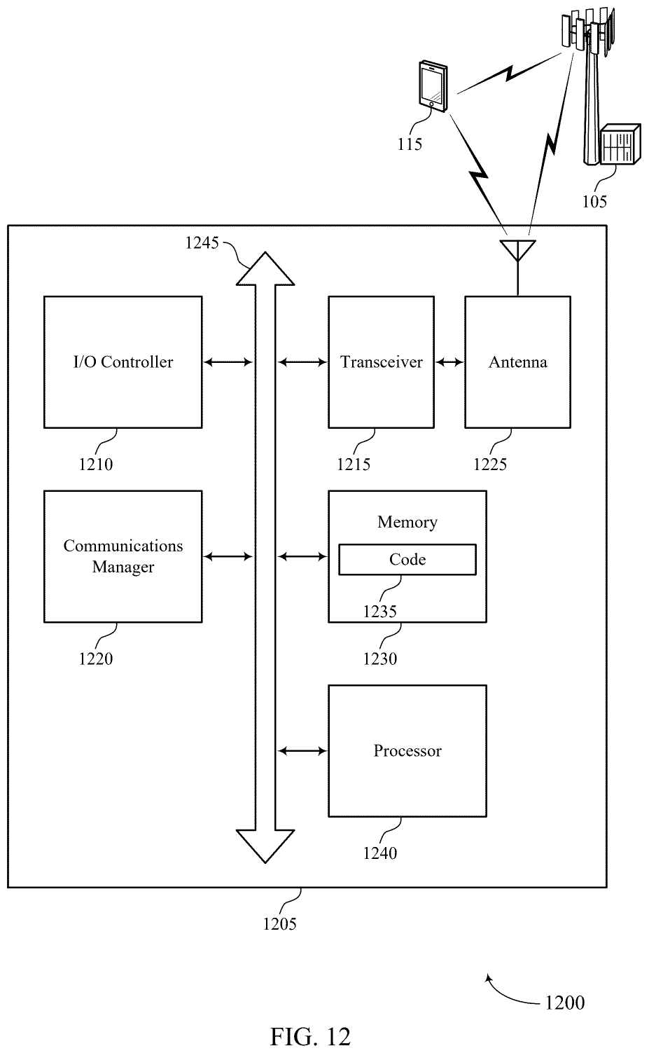

FIG. 12 shows a diagram of a system 1200 including a device 1205 that supports techniques for prediction of uplink traffic bursts in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting techniques for prediction of uplink traffic bursts). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for transmitting, a predictive buffer status report associated with a request for a grant for transmission of uplink data and a first time. The communications manager 1220 is capable of, configured to, or operable to support a means for in response to the predictive buffer status reporting, receiving the grant for transmission of the uplink data for a second time, where the second time is related to the first time. The communications manager 1220 is capable of, configured to, or operable to support a means for transmitting the uplink data based on the grant.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of techniques for prediction of uplink traffic bursts as described herein, or the at least one processor 1240 and the at least one memory 1230 may be otherwise configured to, individually or collectively, perform or support such operations.

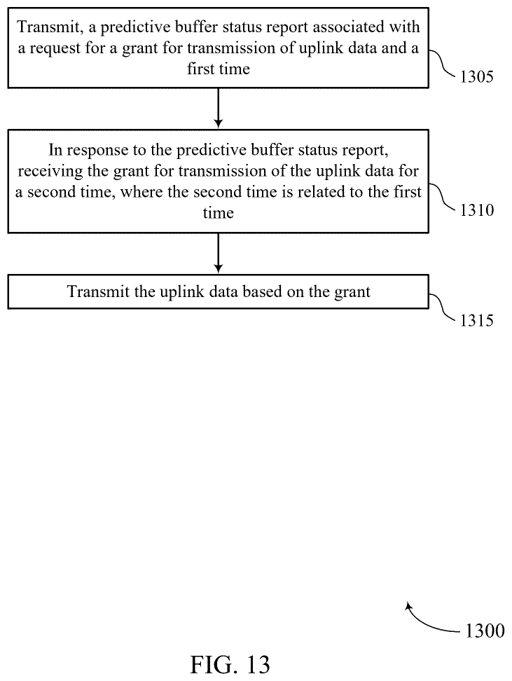

FIG. 13 shows a flowchart illustrating a method 1300 that supports techniques for prediction of uplink traffic bursts in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include transmitting, a predictive buffer status report associated with a request for a grant for transmission of uplink data and a first time. The operations of 1305 may be performed in accordance with examples as disclosed herein. In some examples, aspects of the operations of 1305 may be performed by a predictive buffer status report component 1125 as described with reference to FIG. 11.

At 1310, the method may include in response to the predictive buffer status report, receiving the grant for transmission of the uplink data for a second time, where the second time is related to the first time. The operations of 1310 may be performed in accordance with examples as disclosed herein. In some examples, aspects of the operations of 1310 may be performed by a grant reception component 1130 as described with reference to FIG. 11.

At 1315, the method may include transmitting the uplink data based on the grant. The operations of 1315 may be performed in accordance with examples as disclosed herein. In some examples, aspects of the operations of 1315 may be performed by an uplink component 1135 as described with reference to FIG. 11.

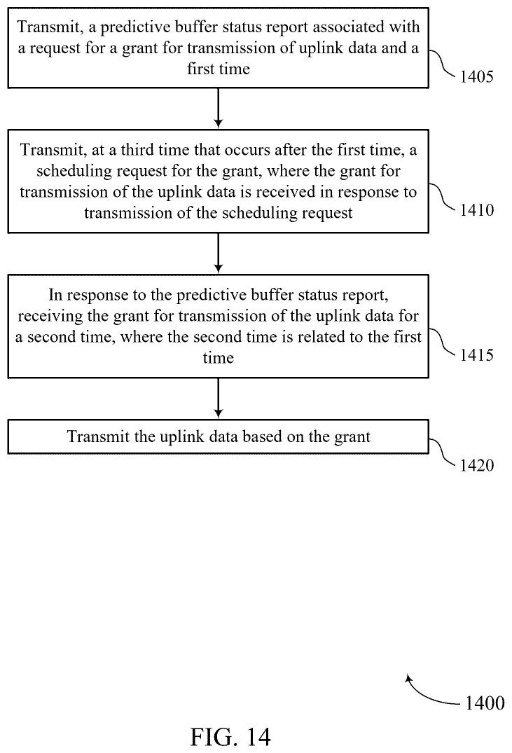

FIG. 14 shows a flowchart illustrating a method 1400 that supports techniques for prediction of uplink traffic bursts in accordance with one or more aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include transmitting, a predictive buffer status report associated with a request for a grant for transmission of uplink data and a first time. The operations of 1405 may be performed in accordance with examples as disclosed herein. In some examples, aspects of the operations of 1405 may be performed by a predictive buffer status report component 1125 as described with reference to FIG. 11.

At 1410, the method may include transmitting, at a third time that occurs after the first time, a scheduling request for the grant, where the grant for transmission of the uplink data is received in response to transmission of the scheduling request. The operations of 1410 may be performed in accordance with examples as disclosed herein. In some examples, aspects of the operations of 1410 may be performed by a scheduling request component 1140 as described with reference to FIG. 11.

At 1415, the method may include in response to the predictive buffer status report, receiving the grant for transmission of the uplink data for a second time, where the second time is related to the first time. The operations of 1415 may be performed in accordance with examples as disclosed herein. In some examples, aspects of the operations of 1415 may be performed by a grant reception component 1130 as described with reference to FIG. 11.

At 1420, the method may include transmitting the uplink data based on the grant. The operations of 1420 may be performed in accordance with examples as disclosed herein. In some examples, aspects of the operations of 1420 may be performed by an uplink component 1135 as described with reference to FIG. 11.

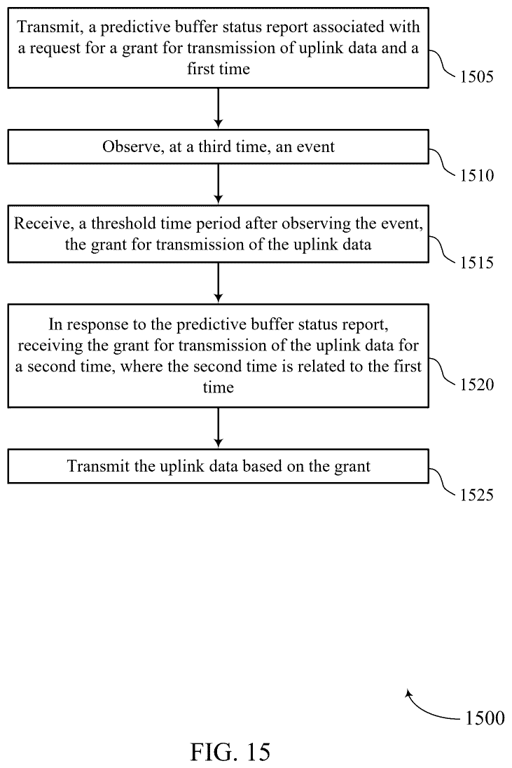

FIG. 15 shows a flowchart illustrating a method 1500 that supports techniques for prediction of uplink traffic bursts in accordance with one or more aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include transmitting, a predictive buffer status report associated with a request for a grant for transmission of uplink data and a first time. The operations of 1505 may be performed in accordance with examples as disclosed herein. In some examples, aspects of the operations of 1505 may be performed by a predictive buffer status report component 1125 as described with reference to FIG. 11.

At 1510, the method may include observing, at a third time, an event. The operations of 1510 may be performed in accordance with examples as disclosed herein. In some examples, aspects of the operations of 1510 may be performed by an event component 1145 as described with reference to FIG. 11.

At 1515, the method may include receiving, a threshold time period after observing the event, the grant for transmission of the uplink data. The operations of 1515 may be performed in accordance with examples as disclosed herein. In some examples, aspects of the operations of 1515 may be performed by a grant reception component 1130 as described with reference to FIG. 11.

At 1520, the method may include in response to the predictive buffer status report, receiving the grant for transmission of the uplink data for a second time, where the second time is related to the first time. The operations of 1520 may be performed in accordance with examples as disclosed herein. In some examples, aspects of the operations of 1520 may be performed by a grant reception component 1130 as described with reference to FIG. 11.

At 1525, the method may include transmitting the uplink data based on the grant. The operations of 1525 may be performed in accordance with examples as disclosed herein. In some examples, aspects of the operations of 1525 may be performed by an uplink component 1135 as described with reference to FIG. 11.

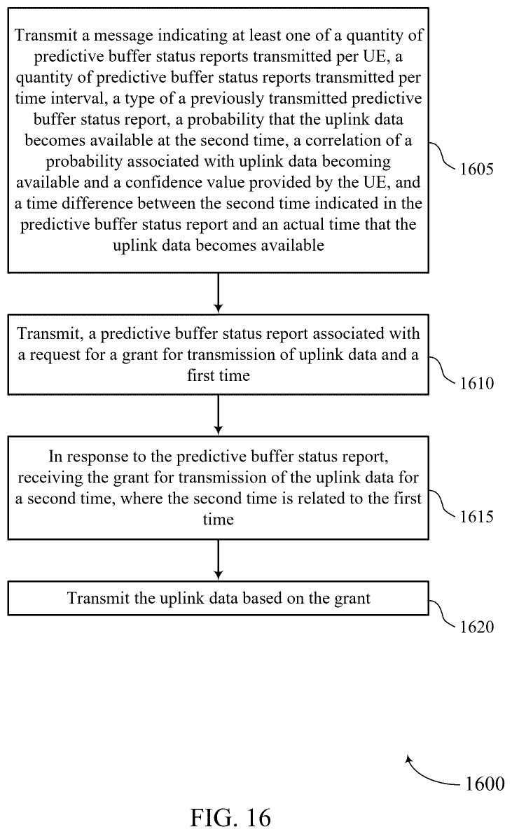

FIG. 16 shows a flowchart illustrating a method 1600 that supports techniques for prediction of uplink traffic bursts in accordance with one or more aspects of the present disclosure. The operations of the method 1600 may be implemented by a UE or its components as described herein. For example, the operations of the method 1600 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1605, the method may include transmitting a message indicating at least one of a quantity of predictive buffer status reports transmitted per UE, a quantity of predictive buffer status reports transmitted per time interval, a type of a previously transmitted predictive buffer status report, a probability that the uplink data becomes available at the second time, a correlation of a probability associated with uplink data becoming available and a confidence value provided by the UE, and a time difference between the second time indicated in the predictive buffer status report and an actual time that the uplink data becomes available. The operations of 1605 may be performed in accordance with examples as disclosed herein. In some examples, aspects of the operations of 1605 may be performed by a predictive buffer status report component 1125 as described with reference to FIG. 11.

At 1610, the method may include transmitting, a predictive buffer status report associated with a request for a grant for transmission of uplink data and a first time. The operations of 1610 may be performed in accordance with examples as disclosed herein. In some examples, aspects of the operations of 1610 may be performed by a predictive buffer status report component 1125 as described with reference to FIG. 11.

At 1615, the method may include in response to the predictive buffer status report, receiving the grant for transmission of the uplink data for a second time, where the second time is related to the first time. The operations of 1615 may be performed in accordance with examples as disclosed herein. In some examples, aspects of the operations of 1615 may be performed by a grant reception component 1130 as described with reference to FIG. 11.

At 1620, the method may include transmitting the uplink data based on the grant. The operations of 1620 may be performed in accordance with examples as disclosed herein. In some examples, aspects of the operations of 1620 may be performed by an uplink component 1135 as described with reference to FIG. 11.

The following provides an overview of aspects of the present disclosure:

Aspect 1: A method for wireless communications at a UE, comprising: transmitting, a predictive buffer status report associated with a request for a grant for transmission of uplink data and a first time; in response to the predictive buffer status report, receiving the grant for transmission of the uplink data for a second time, wherein the second time is related to the first time; and transmitting the uplink data based at least in part on the grant.

Aspect 2: The method of aspect 1, wherein the first time and the second time comprises absolute times.

Aspect 3: The method of any of aspects 1 through 2, wherein the first time comprises a first relative time with respect to an event and the second time comprises a second relative time with respect to the event.

Aspect 4: The method of any of aspects 1 through 3, wherein the predictive buffer status report comprises an indicator for a type of event, the type of event serves as a reference for the first time and the second time.

Aspect 5: The method of any of aspects 1 through 4, wherein receiving the grant further comprises: receiving, in response to the predictive buffer status report, the grant for transmission of the uplink data including an indication of the second time.

Aspect 6: The method of any of aspects 1 through 5, wherein receiving the grant further comprises: receiving, in response to the predictive buffer status report, the grant for transmission of the uplink data after the first time.

Aspect 7: The method of any of aspects 1 through 6, further comprising: transmitting, at a third time that occurs after the first time, a scheduling request for the grant, wherein the grant for transmission of the uplink data is received in response to transmission of the scheduling request.

Aspect 8: The method of any of aspects 1 through 7, further comprising: observing, at a third time, an event; and receiving, a threshold time period after observing the event, the grant for transmission of the uplink data.

Aspect 9: The method of aspect 8, wherein the event comprises a downlink data transmission or an uplink data transmission or both.

Aspect 10: The method of any of aspects 1 through 9, wherein the predictive buffer status report indicates a predicted traffic burst size, a predicted time of burst arrival, a predicted time interval for data availability after an event, an event descriptor, a confidence indicator.

Aspect 11: The method of aspect 10, wherein the event comprises at least one of a successful downlink transmission, a successful uplink transmission, and a traffic characterization.

Aspect 12: The method of any of aspects 1 through 11, further comprising: transmitting a message indicating at least one of a capability to support predictive buffer status reporting, a capability to support time-based predictive buffer status reporting, a capability to support event-based predictive buffer status reporting, and one or more event descriptors.

Aspect 13: The method of any of aspects 1 through 12, further comprising: receiving a control signal indicating for the UE to use predictive buffer status reporting in accordance with one or more of a type of a predictive buffer status report, an event descriptor, or both.

Aspect 14: The method of any of aspects 1 through 13, further comprising: transmitting a message indicating information associated with a usage of one or more predictive buffer status reports.

Aspect 15: The method of any of aspects 1 through 14, further comprising: transmitting a message indicating at least one of a quantity of predictive buffer status reports transmitted per UE, a quantity of predictive buffer status reports transmitted per time interval, a type of a previously transmitted predictive buffer status report, a probability that the uplink data becomes available at the second time, a correlation of a probability associated with uplink data becoming available and a confidence value provided by the UE, and a time difference between the second time indicated in the predictive buffer status report and an actual time that the uplink data becomes available.

Aspect 16: The method of any of aspects 1 through 15, wherein the predictive buffer status report comprises at least one of an indication of an absolute time with reference to an universal time, an absolute time with reference to a system frame number, and a time difference indication.

Aspect 17: A UE for wireless communications, comprising one or more memories storing processor-executable code, and one or more processors coupled with the one or more memories and individually or collectively operable to execute the code to cause the UE to perform a method of any of aspects 1 through 16.

Aspect 18: A UE for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, a predictive buffer status report associated with a request for a grant for transmission of uplink data and a first time;
in response to the predictive buffer status report, receiving the grant for transmission of the uplink data for a second time, wherein the second time is related to the first time; and
transmit the uplink data based at least in part on the grant.

2. The UE of claim 1, wherein:
the first time and the second time comprises absolute times.

3. The UE of claim 1, wherein the first time comprises a first relative time with respect to an event and the second time comprises a second relative time with respect to the event.

4. The UE of claim 1, wherein:
the predictive buffer status report comprises an indicator for a type of event,
the type of event serves as a reference for the first time and the second time.

5. The UE of claim 1, wherein, to receive the grant, the one or more processors are individually or collectively further operable to execute the code to cause the UE to:
receive, in response to the predictive buffer status report, the grant for transmission of the uplink data including an indication of the second time.

6. The UE of claim 1, wherein, to receive the grant, the one or more processors are individually or collectively further operable to execute the code to cause the UE to:
receive, in response to the predictive buffer status report, the grant for transmission of the uplink data after the first time.

7. The UE of claim 1, wherein the one or more processors are individually or collectively further operable to execute the code to cause the UE to:
transmit, at a third time that occurs after the first time, a scheduling request for the grant, wherein the grant for transmission of the uplink data is received in response to transmission of the scheduling request.

8. The UE of claim 1, wherein the one or more processors are individually or collectively further operable to execute the code to cause the UE to:
observe, at a third time, an event; and
receive, a threshold time period after observing the event, the grant for transmission of the uplink data.

9. The UE of claim 8, wherein the event comprises a downlink data transmission or an uplink data transmission or both.

10. The UE of claim 1, wherein the predictive buffer status report indicates a predicted traffic burst size, a predicted time of burst arrival, a predicted time interval for data availability after an event, an event descriptor, a confidence indicator.

11. The UE of claim 10, wherein the event comprises at least one of a successful downlink transmission, a successful uplink transmission, and a traffic characterization.

12. The UE of claim 1, wherein the one or more processors are individually or collectively further operable to execute the code to cause the UE to:
transmit a message indicating at least one of a capability to support predictive buffer status reporting, a capability to support time-based predictive buffer status reporting, a capability to support event-based predictive buffer status reporting, and one or more event descriptors.

13. The UE of claim 1, wherein the one or more processors are individually or collectively further operable to execute the code to cause the UE to:
receive a control signal indicating for the UE to use predictive buffer status reporting in accordance with one or more of a type of a predictive buffer status report, an event descriptor, or both.

14. The UE of claim 1, wherein the one or more processors are individually or collectively further operable to execute the code to cause the UE to:
transmit a message indicating information associated with a usage of one or more predictive buffer status reports.

15. The UE of claim 1, wherein the one or more processors are individually or collectively further operable to execute the code to cause the UE to:
transmit a message indicating at least one of a quantity of predictive buffer status reports transmitted per UE, a quantity of predictive buffer status reports transmitted per time interval, a type of a previously transmitted predictive buffer status report, a probability that the uplink data becomes available at the second time, a correlation of a probability associated with uplink data becoming available and a confidence value provided by the UE, and a time difference between the second time indicated in the predictive buffer status report and an actual time that the uplink data becomes available.

16. The UE of claim 1, wherein the predictive buffer status report comprises at least one of an indication of an absolute time with reference to an universal time, an absolute time with reference to a system frame number, and a time difference indication.

17. A method for wireless communications at a user equipment (UE), comprising:
transmitting, a predictive buffer status report associated with a request for a grant for transmission of uplink data and a first time;
in response to the predictive buffer status report, receiving the grant for transmission of the uplink data for a second time, wherein the second time is related to the first time; and
transmitting the uplink data based at least in part on the grant.

18. The method of claim 17, wherein the first time and the second time comprises absolute times.

19. The method of claim 17, wherein the first time comprises a first relative time with respect to an event and the second time comprises a second relative time with respect to the event.

20. A non-transitory computer-readable medium storing code for wireless communications, the code comprising instructions executable by one or more processors to:
transmit, a predictive buffer status report associated with a request for a grant for transmission of uplink data and a first time;
in response to the predictive buffer status report, receiving the grant for transmission of the uplink data for a second time, wherein the second time is related to the first time; and
transmit the uplink data based at least in part on the grant.
